(19) United States
(12) Patent Application Publication
(10) Pub. No.: US 2026/0111324 A1
(43) Pub. Date: Apr. 23, 2026

(54) MANAGING SHUTDOWN AND RESET OF A NETWORK INTERFACE CARD (NIC)

(71) Applicant: NetApp, Inc., San Jose, CA (US)

(72) Inventors: Yuepeng Qi, Cary, NC (US); Houze Xu, Lexington, MA (US)

(73) Assignee: NetApp, Inc., San Jose, CA (US)

(21) Appl. No.: 18/924,773

(22) Filed: Oct. 23, 2024

(51) Int. Cl. G06F 9/4401; G06F 15/173

(52) U.S. Cl. CPC G06F 11/3051; G06F 11/3031; G06F 11/221

(57) ABSTRACT

Managing shutdown and reset of a network interface card (NIC) in response to an error condition is disclosed. An indication to initiate a network interface card (NIC) reset and reconnection sequence is received. A notification of a link down condition is transmitted. Pending connections are disconnected. Queue pairs corresponding to the interconnect channels are destroyed. Links corresponding to the NIC are disconnected. Packets are cleared from queues corresponding to the NIC. Send and receive queues are reset. Queue pairs corresponding to the NIC are recreated. Queue pairs are connected to corresponding links. Data transfer resumes over the links.

### BACKGROUND

A node, such as a server, a computing device, a virtual machine, etc., may host a storage operating system. The storage operating system may be configured to store data on behalf of client devices, such as within volumes, aggregates, storage devices, cloud storage, locally attached storage, etc. In this way, a client can issue a read operation or a write operation to the storage operating system of the node in order to read data from storage or write data to the storage. The storage operating system may implement a storage file system through which the data is organized and accessible to the client devices. The storage file system may be tailored for managing the storage and access of data within hard drives, solid state drives, cloud storage, and/or other storage that may be relatively slower than memory or other types of faster and lower latency storage.

Nodes generally interact with each other via network connections and communications over network connections involves the use of network interface cards (NICs). NICs can be reset for various purposes including, for example, an error condition. When the NIC reset happens, the transmission of any acknowledgment messages is gone. Without the ability to handle the acknowledgements data can be handled incorrectly or inefficiently.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a block diagram of an example interconnection of two cloud storage nodes.

FIG. 2 is an example high-level flow diagram for when an error occurs (internal or external) and the NIC reset mechanism is triggered.

FIG. 3 is an example high-level flow diagram for an innovative NIC reset process to support managing shutdown of the NIC in response to an error or migration condition.

FIG. 4 is an example high-level flow diagram for an innovative NIC reconnection process to support managing reset of the NIC in response to an error condition.

FIG. 5 is a block diagram of an example system to provide for an innovative NIC reset and reconnection to support managing shutdown of the NIC in response to an error or migration condition.

FIG. 6 illustrates one embodiment of block diagram of a plurality of nodes interconnected as a cluster.

FIG. 7 illustrates one embodiment of a block diagram of a node.

### DETAILED DESCRIPTION

In the following description, for the purposes of explanation, numerous specific details are set forth in order to provide a thorough understanding of the present disclosure. It will be apparent, however, to one skilled in the art that the present disclosure may be practiced without some of these specific details. In other instances, well-known structures and devices are shown in block diagram form to avoid obscuring the underlying principles of the present disclosure.

As mentioned above, when a NIC reset happens, transmission of acknowledgment messages can be lost. In example approaches described below, an IC transport layer can handle this scenario to provide an innovative NIC reset and reconnection process to support managing shutdown of the NIC in response to an error (or migration) condition. Because there can be multiple IC channels to communicate with partner nodes, multiple channels may be shut down cleanly, and resources reclaimed. In an example, traffic for both data and management are reliably transported, so if there is pending management traffic the components described below handle this situation cleanly. A NIC reset can occur as a result of an error detection, in response to a node migration that should be transparent to the user, or for another reason.

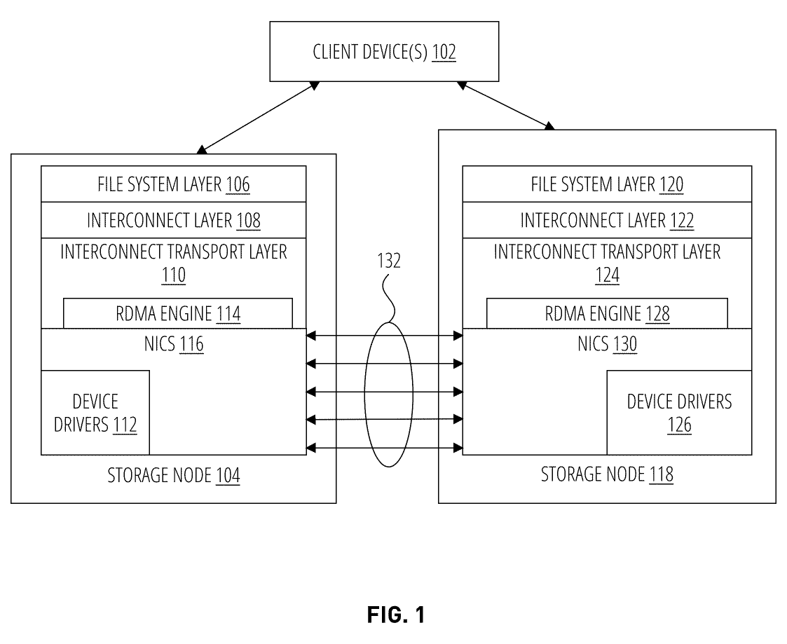

FIG. 1 is a block diagram of an example interconnection of two cloud storage nodes. When two cloud storage nodes are connected (e.g., HA Pairs), multiple channels (e.g., interconnect channels 132) are utilized to manage communication between the nodes (e.g., storage node 104, storage node 118).

In an example, each node can have multiple network interface cards (NICs). However, the NIC reset operations as described herein are not necessarily applied to all NICs at the same time. For example, in a live migration situation, only one NIC may support an RDMA stack, and that NIC can be reset as described below, while other NICs are reset/managed in other ways. In another example, two or more NICs can be reset as described and one or more other NICs can be reset in other ways.

In the example architecture of FIG. 1, each storage node (e.g., storage node 104, storage node 118) includes a file system layer (e.g., file system layer 106, file system layer 120), an interconnect layer (e.g., interconnect layer 108, interconnect layer 122), an interconnect transport layer (e.g., interconnect transport layer 110, interconnect transport layer 124) can include an RDMA engine (e.g., RDMA engine 114, RDMA engine 128) and a set of NICs (e.g., NICs 116, NICs 130), which can utilize corresponding device drivers (e.g., device drivers 112, device drivers 126). In an example, storage nodes run an operating system, for example, the Data ONTAP® operating system available from NetApp™, Inc., Sunnyvale, Calif. However, it is expressly contemplated that any appropriate storage operating system may be enhanced for use in accordance with the inventive principles described herein.

The file system layer provides functionality with respect to storage, organization and other management of data within the storage node. The interconnect layer provides functionality with respect to the transfer of data between the file system layer and the interconnect transport layer. The interconnect transport layer provides functionality with respect to the transfer of data by the one or more NICs from (e.g., NICs 116 and/or NICs 130) over interconnect channels 132.

When a storage node shuts down, each channel should be shut down and reset cleanly. In an example, the approach described herein is designed to work with, for example, eMulated Virtual Interface Architecture (MVIA) NICs but can be applied to other NICs. Nothing in the description should be read to limit the described concepts as being limited to MVIA NICs. MVIA is an abstraction layer used by the RDMA (Remote Direct Memory Access) engine to interact with underlying NICs (e.g., NICs 116, NICs 130). In an example, MVIA is used in NetApp virtual platforms (e.g., AWS FSx and AWS Cloud Volume ONTAP) for high-speed and low-latency communication between HA (High Availability) pairs (e.g., storage node 104 and storage node 118). In an example, MVIA runs on top of NICs provided by cloud vendors (e.g., NICs 116, NICs 130) in the interconnect transport layer (e.g., interconnect transport layer 110, interconnect transport layer 124). In an example, only one NIC from NICs 116 utilizes RDMA engine 114 and only one NIC from NICs 130 utilizes RDMA engine 128. In other configurations multiple RDMA stacks may be utilized by multiple NICs.

In an example, the cloud vendor can be an Amazon Web Services (AWS)-based environment. AWS is provided by Amazon Web Services, Inc., a subsidiary of Amazon.com, Inc. Other environments (e.g.., AZURE from MICROSOFT, Google Cloud Platform from GOOGLE, Alibaba Cloud from ALIBABA, Oracle Cloud from ORACLE, IBM Cloud from IBM, VMWare Cloud from VMWare, Salesforce Cloud from SALESFORCE.COM, INC., or any other suitable environment) can also be supported.

If a NIC reset occurs in the cloud infrastructure, without the approach described herein recovers the RDMA stack in bad health without a reboot of the controller if the current RDMA stack falls into bad health and requires reboot of the controller to recover. Instead, with the approach described below, the RDMA stack can recover from NIC resets gracefully without need of a costly controller reboot.

In an example, the basis of resetting the NIC card exists in the driver (e.g., device drivers 112, device drivers 126); proper and timely release of resources by RDMA stack is addressed in this feature. There are two categories of NIC reset: 1) Internally, when the driver detects bad health of the device, a reset gets performed automatically; and 2) Externally, when a specific value is written into the NIC firmware register (or other triggering mechanism).

In an example, A NIC reset can occur as part of a live migration as a background process in a cloud storage environment. These migrations should be transparent to the guest OS when they occur; however, using current techniques and hardware, these migrations are not transparent. Specifically, when a NIC reset occurs, there are generally transactions in various queues associated with the NIC that must be handled cleanly and properly to allow the migration (or reset for any other purpose) to be transparent. Blindly resetting the queues does not accomplish that. Thus, current solutions are insufficient, and the approach described herein addresses these issues to provide a transparent NIC reset.

Currently, when the NIC reset happens, support for the transmission of acknowledgment messages to complete transactions is gone. So, the IC transport layer (e.g., interconnect transport layer 110, interconnect transport layer 124) handles that part, utilizing additional functionality illustrated and described below. In an example, because there are multiple IC channels to communicate with partners, those channels are to be shut down cleanly, and resources are reclaimed. Because the IC layer (e.g., interconnect layer 108, interconnect layer 122) is a reliable delivery mechanism for both data and management traffic, each request has an acknowledgement. In an example, if there is any pending management traffic that is not acknowledged by the partner node, the sending node will keep sending the data.

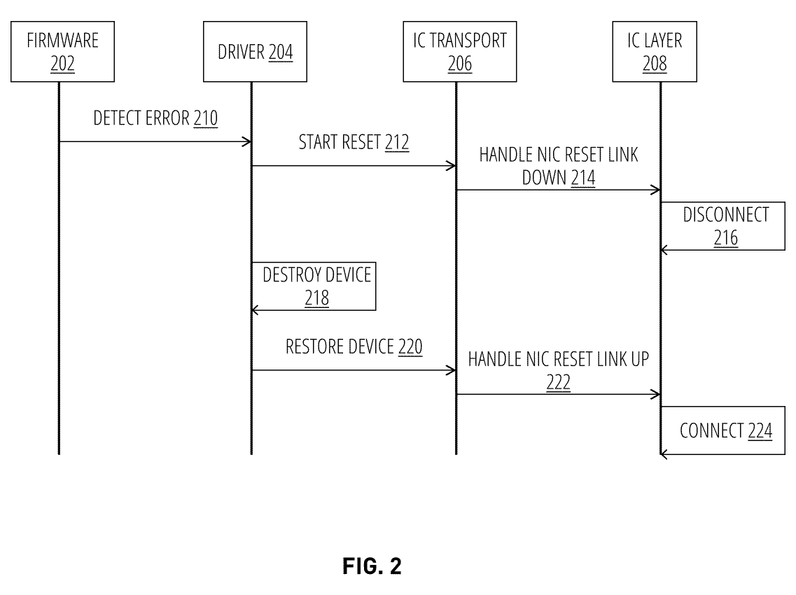

FIG. 2 is an example high-level flow diagram for when an error occurs (internal or external) and the NIC reset mechanism is triggered. The operations as illustrated in FIG. 2 occur within and between firmware 202, driver 204, IC transport 206 and IC layer 208, which can be, for example, part of a storage node (e.g., storage node 104, storage node 118). Other types of nodes can also be supported.

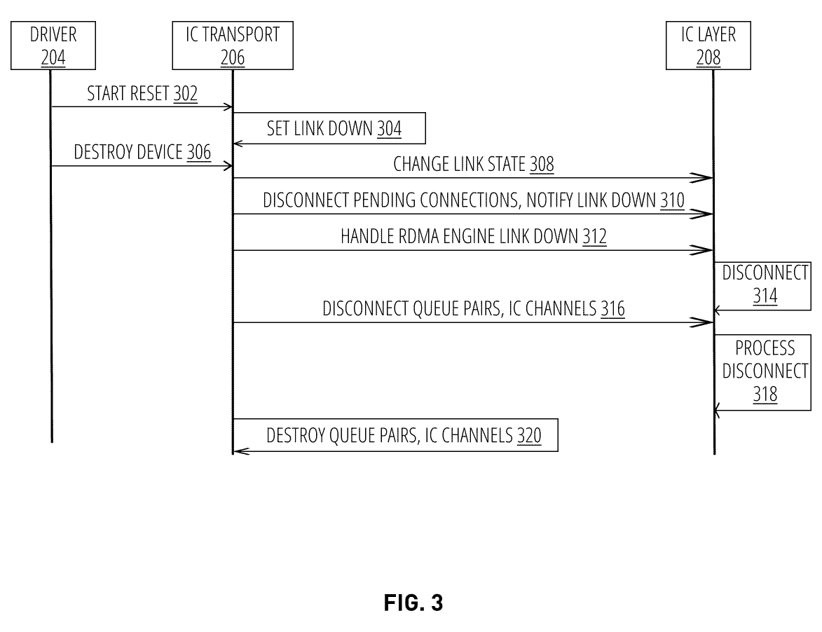

As FIG. 2 illustrates, at a high level when an error occurs as detected (e.g., detect error 210) by firmware 202, driver 204 is notified of the error. In response, driver 204 starts the reset process (e.g., start reset 212) by at least notifying IC transport 206 (e.g., interconnect transport layer 110 in FIG. 1). In an example, the notification (e.g., start reset 212) from driver 204 causes the IC transport layer to reset the IC link associated with the NIC and driver (e.g., handle NIC reset link down 214), which results in disconnect 216 at the IC layer level. The reset can be started in response to detection of an error condition or in response to a live migration (or other non-error reasons). An example approach to handling the disconnect portion of the NIC reset operations is provided in FIG. 3.

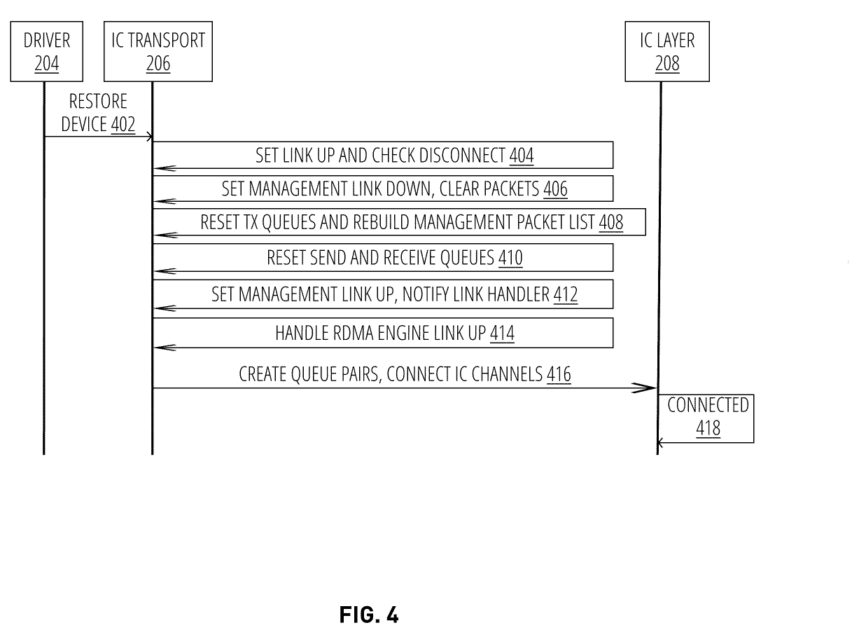

After disconnect 216, driver 204 releases of resources by RDMA stack (e.g., destroy device 218) and restores the connection (e.g., restore device 220). This causes IC transport 206 to reset the IC link (e.g., handle NIC reset link up 222) and IC layer 208 establishes the connection (e.g., connect 224). An example approach to handling the reconnect portion of the NIC reset operations is provided in FIG. 4.

Note that the functionality provided by IC transport 206 illustrated in FIG. 2 improves the overall NIC reset mechanism to overcome the shortcomings described above. In an example, this functionality can be provided as part of the operations implemented as part of the RDMA stack. In other configurations, this functionality can be provided by other components of (or associated with) the storage node. In an example, the NICs being managed (reset and otherwise utilized) are provided by cloud storage providers that are utilized to access cloud storage devices. The functionality described to manage and reset the NICs can reside in an operating system that is not provided by the cloud storage provider. One such operating system is ONTAP® as mentioned above. However, it is expressly contemplated that any appropriate storage operating system may be enhanced for use in accordance with the principles described herein. In an example, the ONTAP operating system (e.g., AWS FSx and/or AWS Cloud Volume ONTAP) can provide (or control the functionality of) the resetting one or more NICs.

FIG. 3 is an example high-level flow diagram for an innovative NIC reset process to support managing shutdown of the NIC in response to an error or migration condition. The illustrated approach to the implementation provides support for resetting a cloud vendor NIC utilizing, for example, the ONTAP operating system (e.g., AWS FSx and/or AWS Cloud Volume ONTAP). The basis for resetting the NIC exists in the driver; here, the proper release of resources and timely bring-up of IC transport is required. What follows is the description of this improvement in three aspects: 1) release of outstanding transmissions, 2) reset of IC transport data path, and 3) reset of IC transport management path.

In an example, reliable delivery of information requests are maintained for each IC channel. The release of this information is supported by the functionality illustrated in FIG. 3 to handle the NIC reset. First, for requests that failed to be sent by the NIC driver due to NIC's busy state, reliable delivery information gets released when IC channels get destroyed (e.g., destroy queue pairs, IC channels 320). Second, for requests sent on wire by the NIC driver but not acknowledged, their reliable delivery information is released when IC channels are destroyed (e.g., destroy queue pairs, IC channels 320). Third, a relatively short time is added before releasing reliable delivery information of an IC channel if transmission is not drained. Mechanisms to achieve these objectives are illustrated in FIG. 3.

In an example, in response to a start reset 302 message from driver 204, IC transport 206 performs a set link down 304 operations to stop transmissions over the corresponding IC channel (not illustrated in FIG. 3). The reset can be started in response to detection of an error condition or in response to a live migration (or other non-error reasons). In an example, set link down 304 is a management path link-down flag (or other indicator) that is set after IC transport 206 starts resetting the management path for the IC channel. In an example, set link down 304 is used to bail out from processing new management packets received and new transmission completions on packets sent.

In an example, after start reset 302 from driver 204, driver 204 initiates destroy device 306. In an example, IC transport 206 clears the available management packet list after setting the management path link down flag (e.g., set link down 304) and rebuilding it after releasing all outstanding transmissions, which is described in greater detail below. As illustrated in FIG. 4, IC transport 206 also resets the send queue and receive queue of management packets before unsetting the management path link-down flag. In an example, a link down by reset flag is added by IC transport 206, which stops incoming requests from IC clients after the NIC underlying IC transport is reset.

Returning to the flow of FIG. 3, in an example, after set link down 304, IC transport 206 causes operations to be performed that clear the relevant queues to support the innovative NIC reset process to support managing shutdown and reset of the NIC in response to an error condition. The release of outstanding requests is performed by IC transport 206 depending on which stage the requests are in at the time of the reset. In an example, IC transport 206 causes change link state 308, then disconnect pending connections, notify link down 310 and handle RDMA engine link down 312. As a result, first, transmissions not posted to the RDMA engine are dropped and returned to IC clients with a post-send error. Second, transmissions posted to the RDMA engine but not reaching the NIC driver are released after the management path of IC transport completes the link down by reset. Third, for transmissions sent to the NIC driver but not released yet, they are released after the IC transport management path completes the processing link down. Their copies in the NIC driver are released by the driver when destroying the device.

In an example, IC layer 208 then disconnects the IC link (e.g., disconnect 314) and IC transport 206 can disconnect queue pairs, IC channels 316. In response IC layer 208 processes the disconnect (e.g., process disconnect 318) and IC transport 206 causes destroy queue pairs, IC channels 320 to be performed. At this point, the proper release of resources and timely bring-up of IC transport has been provided. In an example, this includes: 1) release of outstanding transmissions, 2) reset of IC transport data path, and 3) reset of IC transport management path.

FIG. 4 is an example high-level flow diagram for an innovative NIC reconnection process to support managing reset of the NIC in response to an error condition. As FIG. 4 illustrates, as part of the NIC reset process (e.g., in response to restore device 402 from driver 204,link handler operations are provided to manage IC transport 206 operations in support of the NIC reset and the corresponding IC layer connections. The link handler operations manage the processing and notifications (e.g., acknowledgments) associated with pending transactions at the time of the NIC reset. In the example of FIG. 4, this is accomplished usingcommands and functionality at the IC transport 206 level.

In an example, driver 204 sends a restore device 402 message to IC transport 206 to reset the NIC. This is associated with driver 204 sending a start reset 212 message to IC transport 206 as illustrated in FIG. 2. In an example, the operations triggered by and associated with restore device 402 are a subset of the operations triggered by and associated with start reset 212. In some configurations they can be the same set of operations. In an example, the management path uses and maintains multiple lists of pre-allocated management packets. The release and rebuild of these packet lists are used to handle NIC reset events (as described in greater detail with respect to the operations illustrated in FIG. 4).

In response to receiving the restore device 402 message, IC transport 206, sets (or checks) an indicator that indicates the link from the NIC being reset is up. In response to the restore device 402 message, IC transport 206 causes the following set of operations to be executed: set link up and check disconnect 404, set management link down, clear packets 406, reset outstanding transmission (Tx) queues and rebuild management packet list 408, reset send and receive queues 410, set management link up, notify link handler 412, handle RDMA engine link up 414 and create queue pairs, connect IC channels 416. At this point, the new connections are ready to receive traffic again (e.g., connected 418). The RDMA stack has been cleanly reset and reconnected and is ready to resume operations.

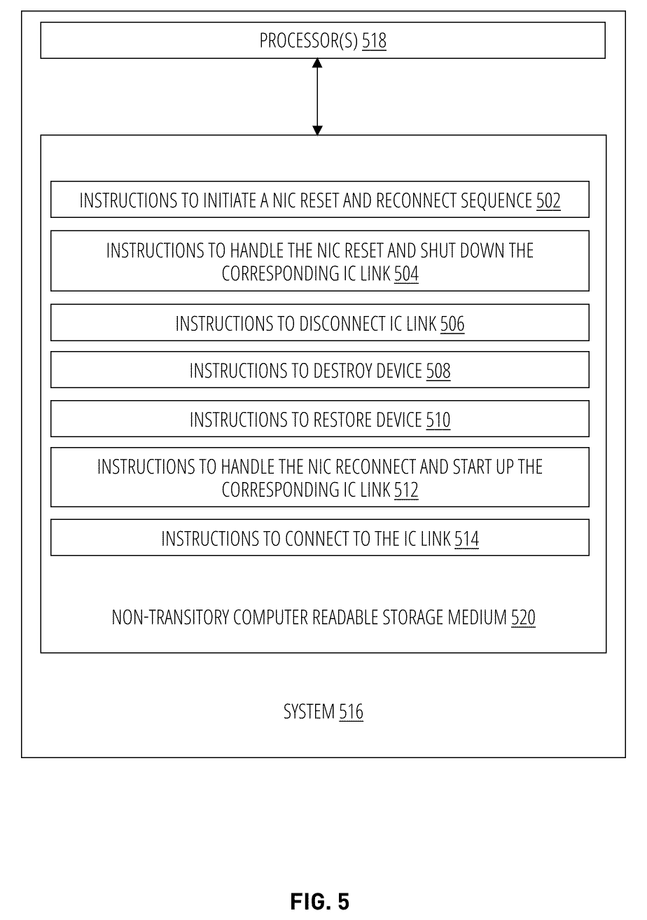

FIG. 5 is a block diagram of an example system to provide for an innovative NIC reset and reconnection to support managing shutdown of the NIC in response to an error or migration condition. In an example, system 516 can include processor(s) 518 and non-transitory computer readable storage medium 520. In an example, processor(s) 518 and non-transitory computer readable storage medium 520 can be part of a management node having a storage operating system that can provide some or all of the functionality of the ONTAP software as mentioned above.

Non-transitory computer readable storage medium 520 may store instructions 502, 504, 506, 508, 510, 512 and 514 that, when executed by processor(s) 518, cause processor(s) 518 to perform various functions. Examples of processor(s) 518 may include a microcontroller, a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of non-transitory computer readable storage medium 520 include tangible media such as random-access memory (RAM), read-only memory (ROM), electrically erasable programmable read-only memory (EEPROM), flash memory, a hard disk drive, etc.

Instructions 502 cause processor(s) 518 to initiate a NIC reset and reconnect sequence. This can be in response to an error detection (e.g., detect error 210) or in response to a live migration operation (e.g., where one or more connections are transparently (to the client device) migrated to new NICs). Other conditions can also result in initiation of the NIC reset and reconnect sequence. In an example, initiation of the NIC reset is accomplished by the driver (e.g., driver 204) sending one or more instructions to IC transport 206 to indicating a start to the reset sequence.

Instructions 504 cause processor(s) 518 to cause the IC transport layer (e.g., IC transport 206) to handle the NIC reset and shut the corresponding link down (e.g., handle NIC reset link down 214). In an example, this sequence of resetting the NIC and shutting down the link involves setting an indicator, for example, a flag, that the link is down (e.g., set link down 304), changing the link state to down (e.g., change link state 308), and disconnecting pending connections and notifying endpoints of the link down condition (e.g., disconnect pending connections, notify link down 310).

Instructions 506 cause processor(s) 518 to cause the IC layer (e.g., IC layer 208) to disconnect (e.g., disconnect 314) the link that has been shut down. Queue pairs and corresponding IC channels are then disconnected (e.g., disconnect queue pairs, IC channels 316) and the disconnect is processed (e.g., process disconnect 318).

Instructions 508 cause processor(s) 518 to cause the driver (e.g., driver 204) to destroy (e.g., destroy device 218) the device using the IC link that has been shut down. In an example, this can include destroying queue pairs and corresponding IC channels (e.g., destroy queue pairs, IC channels 320).

Instructions 510 cause processor(s) 518 to cause the driver (e.g., driver 204) to restore (e.g., restore device 220) the device using same IC link (in the case of an error condition recovery) or using a new IC link (in the case of a live migration).

Instructions 512 cause processor(s) 518 to cause the IC transport layer (e.g., IC transport 206) to handle the NIC reset and start up the corresponding link (e.g., handle NIC reset link up 222). In an example, this sequence of resetting the NIC and restarting the link involves setting up the link (e.g., set link up and check disconnect 404), set the management link to down and clear any packets (e.g., set management link down, clear packets 406), reset queues and rebuild management packet lists (e.g., reset Tx queues and rebuild management packet list 408), reset send and receive queues (e.g., reset send and receive queues 410), set up a link to the RDMA engine (e.g., handle RDMA engine link up 414) and create queue pairs to connect to IC channels/links (e.g., create queue pairs, connect IC channels 416).

Instructions 514 cause processor(s) 518 to cause the IC layer (e.g., IC layer 208) to connect the link that has been shut down.

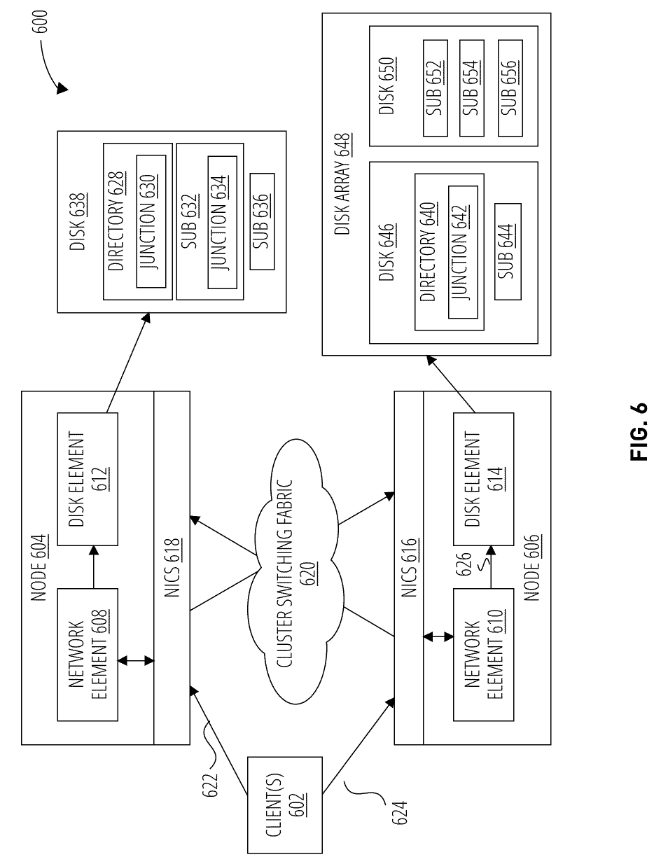

FIG. 6 illustrates one embodiment of block diagram of a plurality of nodes interconnected as a cluster. The cluster of nodes illustrated in FIG. 6 can be configured to provide storage services using NICs for communication, where the NICs are reset and reconnected as described herein. The example of FIG. 6 provides a higher-level description than the storage nodes illustrated in FIG. 1 and further illustrate how each node can support multiple NICs (e.g., NICs 616, NICs 618) that can be managed using the approaches described herein.

The nodes of FIG. 6 (e.g., node 604, node 606) include various functional components that cooperate to provide a distributed storage system architecture of cluster 600. To that end, each node is generally organized as a network element (e.g., network element 608 in node 604, network element 610 in node 606) and a disk element (e.g., disk element 612 in node 604, disk element 614 in node 606). The network elements provide functionality that enables the nodes to connect to client(s) 602 over one or more network connections (e.g., 622, 624), while each disk element connects to one or more storage devices (e.g., disk 638, disk array 648).

In the example of FIG. 6, disk element 612 connects to disk 638 and disk element 614 connection to 648 (which includes disk 646 and 650). Node 604 and node 606 are interconnected by cluster switching fabric 620 which, in an example, may be a Gigabit Ethernet switch. It should be noted that while there is shown an equal number of network and disk elements in cluster 600, there may be differing numbers of network and/or disk elements. For example, there may be a plurality of network elements and/or disk elements interconnected in a cluster configuration that does not reflect a one-to-one correspondence between the network and disk elements. As such, the description of a node comprising one network elements and one disk element should be taken as illustrative only.

Client(s) 602 may be general-purpose computers configured to interact with node 604 and node 606 in accordance with a client/server model of information delivery. That is, each client may request the services of a node, and the corresponding node may return the results of the services requested by the client by exchanging packets over one or more network connections (e.g., 622, 624).

Client(s) 602 may issue packets including file-based access protocols, such as the Common Internet File System (CIFS) protocol or Network File System (NFS) protocol, over the Transmission Control Protocol/Internet Protocol (TCP/IP) when accessing information in the form of files and directories. Alternatively, the client may issue packets including block-based access protocols, such as the Small Computer Systems Interface (SCSI) protocol encapsulated over TCP (iSCSI) and SCSI encapsulated over Fibre Channel (FCP), when accessing information in the form of blocks.

Disk elements (e.g., disk element 612, disk element 614) are illustratively connected to disks that may be individual disks (e.g., disk 638) or organized into disk arrays (e.g., disk array 648). Alternatively, storage devices other than disks may be utilized, e.g., flash memory, optical storage, solid state devices, etc. As such, the description of disks should be taken as exemplary only. It should be noted that the distribution of directories, subdirectories and junctions shown in FIG. 6 is for illustrative purposes. As such, the description of the directory structure relating to subdirectories and/or junctions should be taken as exemplary only.

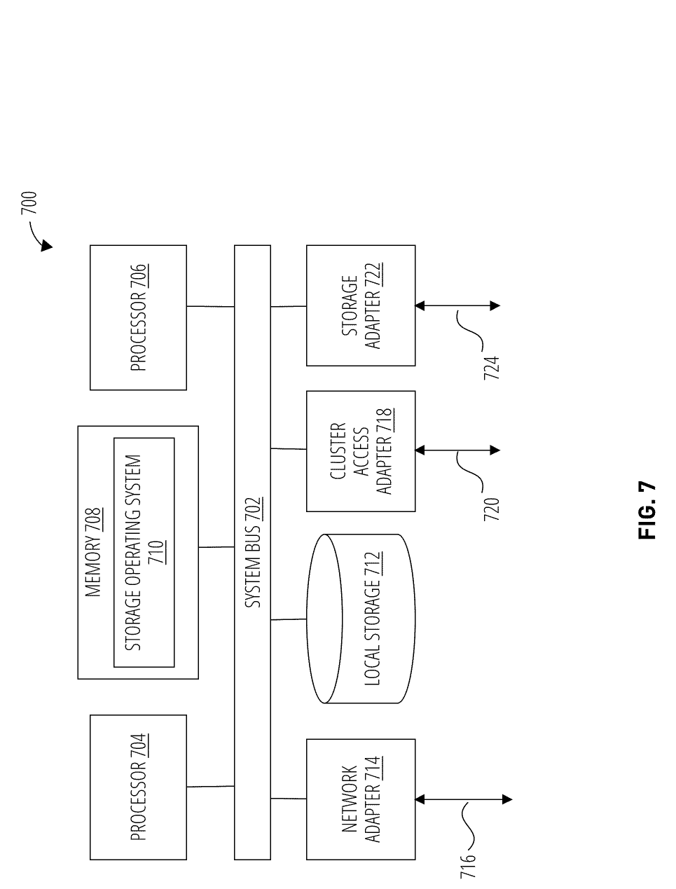

FIG. 7 illustrates one embodiment of a block diagram of a node. Node 700 can be, for example, storage node 104 or storage node 118 as discussed in FIG. 1, node 604 or node 606 as discussed in FIG. 6, etc. The nodes illustrated in FIG. 7 can be managed utilizing the rebalancing strategies (e.g., rebalancing engine(s), rebalancing scanner(s), non-disruptive move mechanism) described herein.

In the example of FIG. 7, node 700 includes processor 704 and processor 706, memory 708, network adapter 714, cluster access adapter 718, storage adapter 722 and local storage 712 interconnected by 202. In an example, local storage 712 can be one or more storage devices, such as disks, utilized by the node to locally store configuration information.

Cluster access adapter 718 provides a plurality of ports adapted to couple node 700 to other nodes (not illustrated in FIG. 7) of a cluster. In an example, Ethernet is used as the clustering protocol and interconnect media, although it will be apparent to those skilled in the art that other types of protocols and interconnects may be utilized within the cluster architecture described herein. Alternatively, where the network elements and disk elements are implemented on separate storage systems or computers, cluster access adapter 718 is utilized by the network element (e.g., network element 608, network element 610) and disk element (e.g., disk element 612, disk element 614) for communicating with other network elements and disk elements in the cluster.

In the example of FIG. 7, node 700 is illustratively embodied as a dual processor storage system executing storage operating system 710 that can implement a high-level module, such as a file system, to logically organize the information as a hierarchical structure of named directories, files and special types of files called virtual disks (hereinafter generally “blocks”) on the disks. However, it will be apparent to those of ordinary skill in the art that node 700 may alternatively comprise a single or more than two processor system. In an example, processor 704 executes the functions of the network element on the node, while processor 706 executes the functions of the disk element.

In an example, memory 708 illustratively comprises storage locations that are addressable by the processors and adapters for storing software program code and data structures associated with the subject matter of the disclosure. The processor and adapters may, in turn, comprise processing elements and/or logic circuitry configured to execute the software code and manipulate the data structures. Storage operating system 710, portions of which is typically resident in memory and executed by the processing elements, functionally organizes node 700 by, inter alia, invoking storage operations in support of the storage service implemented by the node. It will be apparent to those skilled in the art that other processing and memory means, including various computer readable media, may be used for storing and executing program instructions pertaining to the disclosure described herein.

Illustratively, storage operating system 710 can be the Data ONTAP® operating system available from NetApp™, Inc., Sunnyvale, Calif. However, it is expressly contemplated that any appropriate storage operating system may be enhanced for use in accordance with the principles described herein. In an example, the ONTAP operating system can provide (or control the functionality of) the resetting one or more NICs.

In an example, network adapter 714 provides a plurality of ports adapted to couple node 700 to one or more clients (e.g., client(s) 602) over one or more connections 716, which can be point-to-point links, wide area networks, virtual private networks implemented over a public network (Internet) or a shared local area network. Network adapter 714 can include one or more NICs that function and are controlled as described above. Network adapter 714 thus may include the mechanical, electrical and signaling circuitry needed to connect the node to the network. Illustratively, the computer network may be embodied as an Ethernet network or a Fibre Channel (FC) network. Each client may communicate with the node over network connections by exchanging discrete frames or packets of data according to pre-defined protocols, such as TCP/IP.

In an example, to facilitate access to disks, storage operating system 710 implements a write-anywhere file system that cooperates with one or more virtualization modules to “virtualize” the storage space provided by the disks. The file system logically organizes the information as a hierarchical structure of named directories and files on the disks. Each “on-disk” file may be implemented as set of disk blocks configured to store information, such as data, whereas the directory may be implemented as a specially formatted file in which names and links to other files and directories are stored. The virtualization module(s) allow the file system to further logically organize information as a hierarchical structure of blocks on the disks that are exported as named logical unit numbers (LUNs).

In an example, storage of information on each array is implemented as one or more storage “volumes” that comprise a collection of physical storage disks cooperating to define an overall logical arrangement of volume block number (vbn) space on the volume(s). Each logical volume is generally, although not necessarily, associated with its own file system. The disks within a logical volume/file system are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-4 level implementation, although it should be understood that other types and levels of RAID implementations may be used in accordance with the inventive principles described herein.

Storage adapter 722 cooperates with storage operating system 710 to access information requested by the clients. The information may be stored on any type of attached array of writable storage device media such as video tape, optical, DVD, magnetic tape, bubble memory, electronic random-access memory, micro-electromechanical and any other similar media adapted to store information, including data and parity information. However, as illustratively described herein, the information is stored on disks or an array of disks utilizing one or more connections 720. Storage adapter 722 provides a plurality of ports having input/output (I/O) interface circuitry that couples to the disks over an I/O interconnect arrangement, such as a conventional high-performance, CF link topology.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term "logic" may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Reference in the specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment.

It is contemplated that any number and type of components may be added to and/or removed to facilitate various embodiments including adding, removing, and/or enhancing certain features. For brevity, clarity, and ease of understanding, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

The terms “component”, “module”, “system,” and the like as used herein are intended to refer to a computer-related entity, either software-executing general-purpose processor, hardware, firmware and a combination thereof. For example, a component may be, but is not limited to being, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various non-transitory, computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device type, in accordance with the claimed subject matter.

What is claimed is:

1. A non-transitory computer-readable medium having stored thereon instructions that, when executed by one or more hardware processors, cause the one or more hardware processors to:
receive an indication to initiate a network interface card (NIC) reset and reconnection sequence;
transmit a notification of a link down condition;
disconnect pending connections;
destroy one or more queue pairs corresponding to the interconnect channels;
disconnect one or more links corresponding to the NIC;
clear packets from one or more queues corresponding to the NIC;
reset send and receive queues;
recreate one or more queue pairs corresponding to the NIC;
connect the one or more queue pairs to one or more corresponding links;
resume data transfer over the links.

2. The non-transitory computer-readable medium of claim 1, wherein the indication comprises an error notification.

3. The non-transitory computer-readable medium of claim 1, wherein the indication comprises a notification of a live migration.

4. The non-transitory computer-readable medium of claim 1, wherein destroying one or more queue pairs corresponding to the NIC results in: 1) release of outstanding transmissions, if any, 2) reset of an IC transport data path, and 3) reset of an IC transport management path.

5. The non-transitory computer-readable medium of claim 1, wherein the link corresponds to a Remote Direct Memory Access (RDMA) stack in the NIC.

6. The non-transitory computer-readable medium of claim 1, wherein the NIC is part of a storage node in a cloud environment.

7. The non-transitory computer-readable medium of claim 6, wherein the storage node is part of a high-availability (HA) cluster of storage nodes.

8. A method comprising:
receiving an indication to initiate a network interface card (NIC) reset and reconnection sequence;
transmitting a notification of a link down condition;
disconnecting pending connections;
destroying one or more queue pairs corresponding to the interconnect channels;
disconnecting one or more links corresponding to the NIC;
clearing packets from one or more queues corresponding to the NIC;
resetting send and receive queues;
recreating one or more queue pairs corresponding to the NIC;
connecting the one or more queue pairs to one or more corresponding links;
resuming data transfer over the links.

9. The method of claim 8, wherein the indication comprises an error notification.

10. The method of claim 8, wherein the indication comprises a notification of a live migration.

11. The method of claim 8, wherein destroying one or more queue pairs corresponding to the NIC results in: 1) release of outstanding transmissions, if any, 2) reset of an IC transport data path, and 3) reset of an IC transport management path.

12. The method of claim 8, wherein the link corresponds to a Remote Direct Memory Access (RDMA) stack in the NIC.

13. The method of claim 8, wherein the NIC is part of a storage node in a cloud environment.

14. The method of claim 13, wherein the storage node is part of a high-availability (HA) cluster of storage nodes.

15. A system comprising:
a storage subsystem having multiple storage devices;
a network interface card (NIC);
one or more hardware processors coupled with the storage subsystem and with the NIC, the one or more hardware processors configurable to:
receive an indication to initiate a network interface card (NIC) reset and reconnection sequence;
transmit a notification of a link down condition;
disconnect pending connections;
destroy one or more queue pairs corresponding to the interconnect channels;
disconnect one or more links corresponding to the NIC;
clear packets from one or more queues corresponding to the NIC;
reset send and receive queues;
recreate one or more queue pairs corresponding to the NIC;
connect the one or more queue pairs to one or more corresponding links;
resume data transfer over the links.

16. The system of claim 15, wherein the indication comprises an error notification.

17. The system of claim 15, wherein the indication comprises a notification of a live migration.

18. The system of claim 15, wherein destroying one or more queue pairs corresponding to the NIC results in: 1) release of outstanding transmissions, if any, 2) reset of an IC transport data path, and 3) reset of an IC transport management path.

19. The system of claim 15, wherein the link corresponds to a Remote Direct Memory Access (RDMA) stack in the NIC.

20. The system of claim 15, wherein the NIC is part of a storage node in a cloud environment and the storage node is part of a high-availability (HA) cluster of storage nodes.
